(19) United States
(12) Patent Application Publication
(10) Pub. No.: US 2006/0021281 A1
(43) Pub. Date: Feb. 2, 2006

(54) Glass run

(75) Inventors: Kiyotaka Tamaoki, Aichi-ken (JP); Takeshi Ishikawa, Wako-shi (JP)

Correspondence Address: POSZ LAW GROUP, PLC, 12040 SOUTH LAKES DRIVE, SUITE 101, RESTON, VA, 20191, US

(73) Assignees: TOYODA GOSEI CO., LTD, Aichi-ken (JP); HONDA MOTOR CO., LTD., Tokyo (JP)

(21) Appl. No.: 11/194,732

(22) Filed: Aug. 2, 2005

(30) Foreign Application Priority Data
Aug. 2, 2004 (JP) 2004-225545
Aug. 3, 2004 (JP) 2004-226385

(51) Int. Cl. E06B 7/16

(52) U.S. Cl. 49/441

(57) ABSTRACT

A glass run is assembled to an automobile door having a door glass. An upper portion of the glass run includes a main body provided with an interior wall part and formed so as to have a substantially U-shaped cross section, a pair of seal lips which form a seal to the door glass, a pair of engagement projections provided on an interior side surface of the interior wall part and adapted to brought into engagement with engagement recesses of a retainer and a bending portion provided on the interior wall part between both the engagement projections. Then, at the time of mounting the glass run, with the bending portion being bent so as to become convex toward an outside of a vehicle, the engagement projections are inserted into the retainer, and thereafter, by releasing the bent state, both the engagement projections are fitted in the engagement recesses, respectively.

### BACKGROUND OF THE INVENTION

1. Field of the Invention

The present invention relates to a glass run mounted on a vehicle door.

2. Related Art

Generally, a glass run for sealing a peripheral portion of a door glass, which slides, is provided on a door of a vehicle such as an automobile. The glass run has a main body with a substantially U-shaped cross section and a pair of seal lips which extend substantially from distal ends of both side walls of the main body toward an inside of the main body. The main body is brought into engagement with a sash with a substantially C-shaped cross section which is provided on the door. Then, an interior side and an exterior side of the door glass are sealed by means of the pair of seal lips along the peripheral portion of the door glass.

It is considered, however, that other glass run mounting constructions which are different from the glass run mounting construction that has been described above are adopted at a location where the sash cannot be provided.

For example, as a glass run mounting construction that is generally adopted for weather strips, there has existed a glass run mounting construction in which a mount base portion having a pair of engagement projections is fitted in a retainer having a pair of engagement recesses. In this construction, the retainer is formed such that open end portions of the retainer are narrowed so as to have a substantially C-shaped cross section, and the engagement recesses are formed along the edges of the retainer so that the engagement projections of the mount base portion are brought into engagement with the engagement recesses so formed. Then, the engagement projections provided along the edges of the mount base portion of a glass run are pushed into the engagement recesses of the retainer, whereby the glass run is mounted.

When mounting the mount base portion of the glass run on the retainer, it is a general practice to first insert one of the engagement projections of the mount base portion into one of the engagement recesses of the retainer and then to insert the other engagement projection into the other engagement recess to thereby complete the mounting. Here, in case the thickness of the mount base portion (the engagement projections) is set substantially the same as the depth of the retainer (the recesses), since the bottom portion of the retainer is brought into contact with the bottom portion of the mount base portion before a distal end of the other engagement projection rides over an opening in the retainer, there is caused a risk that the mounting work becomes difficult to be performed. In view of the risk, the depth of the retainer (the engagement recesses) is generally set larger than the thickness of the mount base portion (the engagement projections) so that an open space is provided (for example, refer to Japanese Utility Model Publication No. JP-U-7-27957).

Furthermore, there exists a risk that a reaction force received from open end portions of the retainer constitutes disturbance to mounting work when mounting the mount base portion of the glass run on the retainer. To cope with this, in order to reduce the reaction force so as to realize the improvement in the mounting work, there is provided a type of weather strips in which a base portion is deformed to be bent, when it is brought into contact with open end portions of the retainer, so that engagement projections can be pushed into a mount portion relatively easily. There exists another type of weather strips in which, for example, the depth of a retainer is set relatively deeper than conventional weather strips (glass run), and a base portion is deformed to be bent so as to become convex toward a mounting direction (an outside of the main body), thereby facilitating the pushing work of the base portion (engagement projections) (for example, see Japanese Patent Publication No. JP-A-5-262188).

However, as a result of the setting of the depth of the retainer (the engagement recesses) so large, in a state in which the glass run is mounted, since a gap is generated between the mount base portion and the bottom portion of the retainer, a loosening is generated in the mounting direction, and the mount position becomes unstable, depending on cases, leading to a risk that the mount base portion is dislocated from the retainer. As a result, there is caused a risk that the sealing characteristic is reduced and that wind noise is generated. Furthermore, In the type of weather strip like the one disclosed in JP-A-5-262188 in which the base portion is deformed to be bent so as to become convex in the mounting direction, since the depth of the retainer has to be set relatively deep, there is caused a risk that the occurrence of the aforesaid problem is facilitated.

It goes without saying that the aforesaid problem is a problem that may occur when the aforesaid weather strip mounting construction is adopted for a glass run.

### SUMMARY OF THE INVENTION

The invention was made with a view to solving the problem, and an object thereof is to provide a glass run which can realize the improvement in the mounting work thereof and enhance the stability of a state in which the glass run is mounted.

Hereinafter, some aspects of the invention which are suitable for attaining the object will be itemized for description below.

(1) A glass run adapted to be mounted on a vehicle door having a door glass which moves up and down, comprising:
a main body with a substantially U-shaped cross section which comprises a base portion, and an interior wall part and an exterior wall part which extend, respectively, from opposite ends of the base portion;
a pair of seal lips which extend, respectively, from the interior wall part and the exterior wall part toward an inside of the main body so as to form a seal to the door glass;
a pair of engagement projections provided so as to be brought into engagement with a pair of engagement recesses provided in a substantially C-shaped mount portion of said vehicle door; and
a bending portion formed between said engagement projections so as to be deformable to become convex toward an inside of the U-shaped cross section of the main body.

By providing the bending portion, in the mounting work of the glass run, both the engagement projections are inserted into the interior of the mount portion in such a state that the bending portion is deformed to be bent so as to become convex toward the inside of the main body or in such a state that the distance between both the engagement projections on an outside of the main body is reduced, and thereafter, the bent state is released, whereby the bending portion is restored to an original state thereof, and the respective engagement projections are fitted in the respective engagement recesses. Consequently, even in the event that the thickness of the engagement projections is made to be substantially the same in space as the depth of the mount portion (the engagement recesses), the engagement projections can be fitted in the mount portion (the engagement recesses) relatively easily. In other words, the depth of the mount portion (the engagement recesses) does not have to be set extremely larger than the thickness of the engagement projections, and the generation of a gap between the engagement projections and the bottom portion of the mount portion is made difficult in such a state that the glass run is mounted. Consequently, a loosening is made difficult to be generated in the mounting direction of the glass run. Furthermore, when compared with the type in which the base portion is deformed to be bent so as to become convex toward the outside of the main body, since the mounting work does not have to be performed in which the engagement projections are brought into contact with the open end portions of the mount portion so as to be pushed into the mount portion, there is caused no risk that the mounting workability is reduced due to the reaction force received from the open end portions of the mount portion. As a result, the improvement in the mount workability of the glass run can be realized, and the stability of the state in which the glass run is mounted can be enhanced. In addition, since the bending portion is designed such that the bending portion is deformed to be bent so as to become convex toward the inside of the main body, that is, toward a side thereof in which the door glass is inserted, a state is realized in which the bending deformation of the bending portion is restricted by the door glass, whereby the problem is made extremely difficult to occur that the engagement projections are dislocated from the engagement recesses in such a state that the glass run is inserted.

(2) The pair of engagement projections may be provided in the interior wall part so as to be brought into engagement with the pair of engagement recesses provided in the mount portion of the vehicle door, which opens toward an outside of the vehicle; and
the bending portion may be formed between the engagement projections so as to be deformable such that the interior wall part becomes convex toward the outside of the vehicle.

(3) The interior side surface of the interior wall part may be formed so as to have a substantially V-shaped cross section such that a distance between an exterior side surface and the interior side surface of the interior wall part gradually becomes shorter from the respective engagement projections toward the bending portion.

The thickness of the location where the bending portion is provided can be made relatively thin without affecting the shape of the exterior side surface of the interior wall part which constitutes a side which faces the door glass. As a result, the interior wall part (the bending portion) is made easy to be deformed to be bent, thereby making it possible to realize a further improvement in the mount workability of the glass run.

(4) The bending portion may be made thinner than the thickness of other locations on the interior wall part.

(5) A notched portion may be provided in the bending portion.

The bending portion is made easy to be deformed to be bent, thereby making it possible to realize a further improvement in the mount workability of the glass run.

(6) A glass run according to an aspect of the invention may further comprise an extending wall part which extends from a distal end of the interior wall part so as to be locked on a predetermined locking portion.

By providing the extending wall part, since the bending portion can be deformed to be bent by utilizing the extending wall part as an operating portion, the bending portion is made easier to be deformed to be bent, thereby making it possible to realize a further improvement in the mount workability of the glass run. Furthermore, since the extending wall part is locked on the predetermined locking portion, the stability of the state in which the glass run is mounted can be enhanced further.

(7) A glass run adapted to be mounted on a vehicle door having a door glass which moves up and down, comprising:
a main body with a substantially U-shaped cross section which comprises a base portion, and an interior wall part and an exterior wall part which extend, respectively, from opposite ends of the base portion;
a pair of seal lips which extend, respectively, from the interior wall part and the exterior wall part toward an inside of the main body so as to form a seal to the door glass;
a pair of engagement projections provided so as to be brought into engagement with a pair of engagement recesses provided in a substantially C-shaped mount portion (a retainer) of said vehicle door; and
at least an extending lip which extends from the engagement projection or main body for elastic contact or press contact with a bottom portion of the mount portion.

By providing the extending lip, a gap formed between the engagement projection and the bottom portion of the mount portion in such a state that the glass run is mounted can be closed and the movement of the glass run in the mounting direction can be restricted. As a result, the stability of the state in which the glass run is mounted can be enhanced further and hence, the improvement in sealing characteristic can be realized, whereby the generation of wind noise can be suppressed.

In addition, since the extending lip of this means takes the so-called form of a lip to thereby be brought into elastic contact or press contact with the bottom portion of the mount portion, when compared with a case where a projection such as a bead which contacts with the bottom portion of the mount portion, the contact area is extended, so that the contact with the bottom portion of the mount portion is ensured further and the aforesaid function and advantage are provided in a more ensured fashion.

(8) A glass run adapted to be mounted on a vehicle door having a door glass which moves up and down, comprising:
a main body with a substantially U-shaped cross section which comprises a base portion, and an interior wall part and an exterior wall part which extend, respectively, from opposite ends of the base portion;
a pair of seal lips which extend, respectively, from the interior wall part and the exterior wall part toward an inside of the main body so as to form a seal to the door glass;
engagement projections provided in pair on an interior side surface of the interior wall part along a direction in which the interior wall part extends so as to be brought into engagement with a pair of engagement recesses provided in a substantially C-shaped mount portion of said vehicle door and which is made to open toward an outside of a vehicle; and
an extending lip which extends from at least one of both the engagement projections for elastic contact or press contact with a bottom portion of the mount portion.

Since the extending lip is provided on the engagement projection, when fitting the engagement projection in the mount portion during mounting work of the glass run, the operator can handle the extending lip relatively easily, and hence, the reduction in working efficiency of the mounting work can be suppressed.

(9) The extending lip may extend substantially from a distal end of the engagement projection and is formed to be bent so as to have a substantially V-shaped cross section so as to become convex toward the engagement recess which corresponds to the engagement projection.

The elastic force can be obtained in a more ensured fashion, and the engagement projection can easily be fitted in the engagement recess. As a result, the reduction in mount workability of the glass run can be suppressed. Hence, since the protruding amount is increased by such an extent that the extending lip extends, the insertion of the engagement projection becomes easier, thereby making it possible to realize the improvement in mount workability of the glass run.

(10) The engagement projection from which the extending lip extends may be made to be urged against an interior wall surface of the engagement recess which corresponds to the engagement projection.

The dislocation of the engagement projection from the engagement recess is made difficult, and the stability of the state in which the glass run is mounted can be enhanced further.

(11) The engagement projections and the bending portion may be provided on at least a portion which corresponds to an upper portion of the glass run.

(12) The extending lip may be provided on at least one of both the engagement projections which is located on the base portion side.

Since the mounted state at least in the vicinity of the base portion is stabilized, the stability of the state in which the glass run is mounted can be increased. Hence, the increase in sealing characteristic of the glass run can be realized.

### BRIEF DESCRIPTION OF THE DRAWINGS

FIG. 1 is a front view of a door to which a glass run is assembled;

FIG. 2 is a partial cross-sectional view which explains the glass run;

FIG. 3 is a partial cross-sectional view which explains a method for mounting the glass run; and

FIG. 4 is a partial cross sectional view taken along the line II-II in FIG. 1, which explains the glass run and a mounting construction thereof.

### DETAILED DESCRIPTION OF THE PREFERRED EMBODIMENTS

An embodiment of the invention will be described by reference to the drawings.

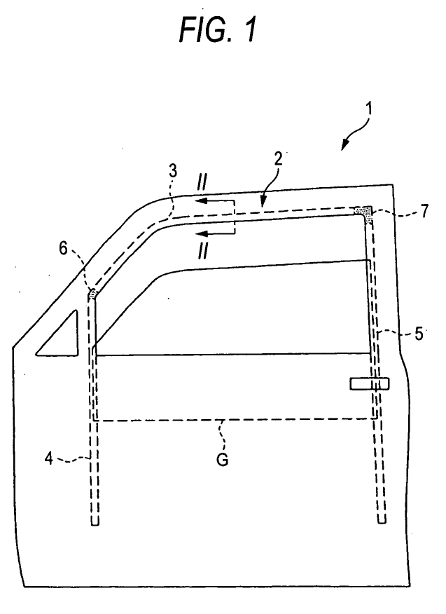

As shown in FIG. 1, an automotive door (a front door in the figure: hereinafter, simply referred to as a door), which functions as a vehicle door provided at an opening in an automobile body as a vehicle main body so as to be opened and closed, includes a door glass G which is adapted to move up and down. A glass run 2 made from EPDM (ethylene-propylene-diene terpolymer) which corresponds to an outer circumferential shape of the door glass G.

As viewed in a longitudinal direction thereof, the glass run 2 is provided with an extruded portion 3 which corresponds to an upper portion of the glass run 2, extruded portions 4, 5 which correspond, respectively, to front and rear vertical portions of the glass run 2 and molded portions 6, 7 (portions given to a dotted pattern in the figure) which connect end portions of the respective extruded portions 3, 4, 5 to each other. The respective extruded portions 3 to 5 are formed substantially linearly by an extruder, not shown. In addition, the molded portions 6, 7 are molded to be connected, respectively, to the two extruded portions 3, 4 and another two extruded portions 3, 5 in such a state that the respective two extruded portions are connected via the molded portions 6, 7 so as to form predetermined angles therebetween by a molding apparatus, not shown.

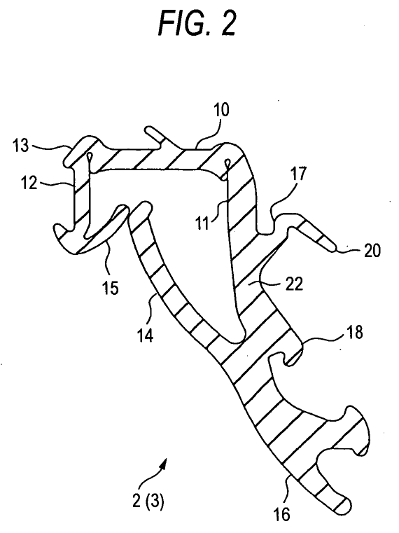

Next, referring to FIGS. 2 to 4, which are partial cross-sectional views taken along the line II-II in FIG. 1, a sealing construction at an upper portion of the door 1 will be described in detail based on the configuration of the upper portion (extruded portion) 3 of the glass run 2 and the configuration of a mount portion of the door 1 on which the glass run 2 is mounted.

Firstly, the configuration of the mount portion at the upper portion of the door 1 on which the upper portion 3 of the glass run 2 is mounted. A retainer S1 as a mount portion, which is provided substantially in parallel with an interior side surface of the door glass G, an exterior member S2, which is provided so as to substantially face an end face of an upper edge portion of the door glass G and an interior member S3, which is provided below the retainer S1, are provided on the upper portion of the door 1.

The retainer S1 includes a bottom wall part 30 which is provided substantially in parallel with the interior side surface of the door glass G to constitute a bottom portion and a pair of upper and lower folding back portions 31, 32 which are bent such that upper and lower ends of the bottom wall part 30 substantially face each other. Namely, the retainer S1 is formed so as to have a substantially C-shaped cross section which is made to open toward an outside of a vehicle and includes a pair of upper and lower engagement recesses 33, 34 which are defined by the folding back portions 31, 32 along upper and lower side portions thereof.

Next, the configuration of the upper portion 3 of the glass run 2 will be described. The upper portion 3 of the glass run 2 includes a main body 13 with a substantially U-shaped cross section which is provided with a base portion 10 that is mounted on the exterior member S2, and an interior wall part 11 and an exterior wall part 12 which extend, respectively, from opposite ends of the base portion 10, a pair of seal lips 14, 15 which extend, respectively, from the interior wall part 11 and the exterior wall part 12 toward an inside of the main body 13 so as to form a seal to the door glass G, an extending wall part 16 which extends from a distal end of the interior wall part 11 so as to be locked on the interior member S3 at a distal end portion thereof, a pair of upper and lower engagement projections 17, 18 which are provided on an interior side surface of the interior wall part 11 so as to be brought into engagement with engagement recesses 33, 34 of the retainer S1 and an extending lip 20 which extends from the upper (the base portion 10 side) engagement projection 17 for elastic contact or press contact with the bottom wall part 30 of the retainer S1. The extending lip 20 extends from a substantially distal end portion of the engagement projection 17 and is formed to be bent so as to have a substantially V-shaped cross section to thereby become convex toward the upper engagement recess 33 which corresponds to the engagement projection 17.

In addition, a bending portion 22 is provided on the interior wall part 11 between both the engagement projections 17, 18 so as to be deformed to be bent so that the interior wall part 11 is allowed to be convex toward an outside of the vehicle. An interior side surface of the interior wall part 11 is formed so as to have a substantially V-shaped cross section such that a distance between an exterior side surface and the interior surface in the interior wall part 11 gradually becomes shorter from the respective engagement projections 17, 18 toward the bending portion 22. Note that the exterior wall part 12 is formed relatively shorter than the interior wall part 11, and in association with this, the exterior seal lip 15 is set relatively smaller (shorter) than the interior seal lip 14, whereby a flush surface is realized in which an exterior side surface of the exterior member S2 becomes flush with an exterior side surface of the door glass G.

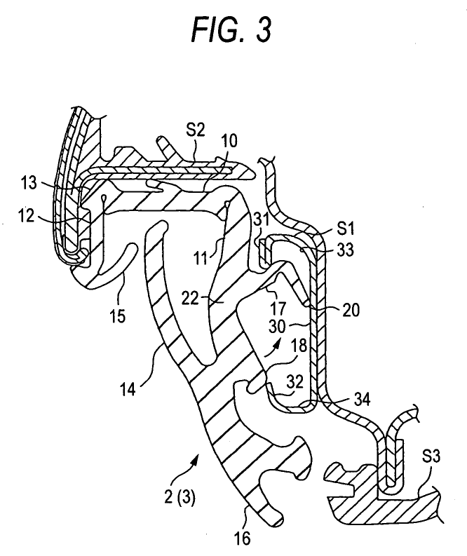

Following this, a function provided when mounting the glass run 2 having the configuration that has just been described will be described below. Firstly, as shown in FIG. 3, with the base portion 10 and the exterior wall part 12 being mounted on the exterior member S2, the engagement projection 17 and the extending lip 20 are inserted into the upper engagement recess 33 of the retainer S1. Following this, the extending wall part 16 is operated so that the bending portion 22 is deformed to be bent, and while realizing a state in which the interior wall part 11 (the bending portion 22) is bent so as to become convex toward the outside of the vehicle or a state in which the lower engagement projection 18 is caused to approach the upper engagement projection 17 (in a direction indicated by an arrow in FIG. 3), the lower engagement projection 18 is inserted into the retainer S1.

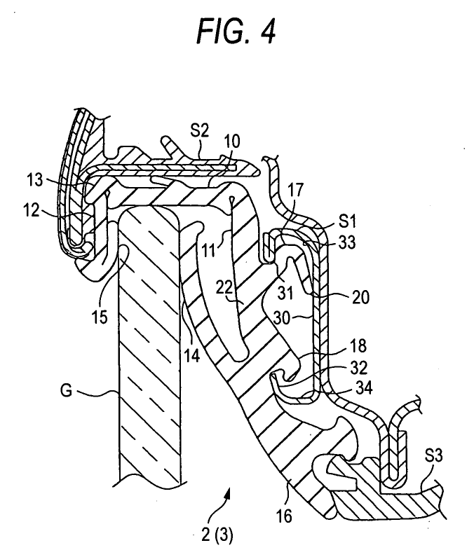

Then, after the engagement projection 18 has been inserted into the retainer S1, the bent state of the interior wall part 11 is released, whereby, as shown in FIG. 4, the interior wall part 11 is restored to an original state thereof, whereby the lower engagement projection 18 is fitted in the lower engagement recess 34 of the retainer S1. Then, the distal end portion of the extending wall part 16 is made to be locked on the interior member S3, completing the mounting of the glass run 2.

In a state in which the glass run 2 is mounted, a state results in which the folding back portions 31, 32 are fitted in narrow portions defined by the interior wall part 11 and the engagement projections 17, 18, whereby the vertical movement of the glass run 2 in vertical directions (ascending and descending directions of the door glass G) is restricted. In addition, the extending lip 20 is brought into contact or press contact with the bottom wall part 30 of the retainer S1 in such a state that the extending lip 20 is elastically deformed. Then, the engagement projection 17 is urged against an interior wall surface of the engagement recess 33 by virtue of the elastic force of the extending lip 20, whereby the lateral movement of the glass run 20 toward the inside and outside of the vehicle is restricted.

Thus, as has been described heretofore, by providing on the interior wall part 11 the bending portion 22 which is adapted to be deformed to be bent so as to become convex toward the outside of the vehicle, in mounting the glass run 2, when compared with the type in which the base portion is deformed to be bent so as to become convex toward the exterior side surface of the interior wall part 11 (the inside of the vehicle), since the mounting work does not have to be performed in which the engagement projections 17, 18 are brought into contact with the open end portions of the retainer S1 so as to be pushed into the retainer S1, there is caused no risk that the mounting workability is reduced due to the reaction force received from the open end portions of the retainer S1. As a result, the improvement in the mount workability of the glass run 2 can be realized.

In addition, since the bending portion 22 is configured such that the bending portion 22 is deformed to be bent so as to be convex toward the inside of the main body 13 or in the direction in which the door glass G is inserted, a state is realized in which the bending deformation of the bending portion 22 is restricted by the door glass G in such a state that the glass run 2 is inserted, whereby the problem is made extremely difficult to occur that the engagement projections 17, 18 are dislocated from the engagement recesses 33, 34.

Additionally, since the interior side surface of the interior wall part 11 is formed so as to have the substantially V-shaped cross section such that the distance from the exterior side surface of the interior wall part 11 thereto becomes gradually shorter from the respective engagement projections 17, 18 toward the bending portion 22, the thickness of the location where the bending portion 22 is provided can be made relatively thin without affecting the shape of the exterior side surface, which is a side facing the door glass G, of the interior wall part 11. As a result, the interior wall part 11 (the bending portion 22) is made easier to be deformed to be bent, thereby making it possible to realize a further improvement in mount workability of the glass run 2.

In addition, by providing the extending wall part 16, since the extending wall part 16 is operated so that the bending portion 22 can be deformed to be bent, the bending portion 22 is made much easier to be deformed to be bent, thereby making it possible to realize a further improvement in mount workability of the glass run 2. Furthermore, since the extending wall part 16 is locked on the interior member S3, the stability of the state in which the glass run 2 is mounted can be enhanced further.

By providing the extending lip 20 which extends from the upper engagement projection 17 for elastic contact or press contact with the bottom wall part 30 of the retainer S1, the gap formed between the engagement projection 17 and the bottom wall part 30 of the retainer S1 in such a state that the glass run 2 is mounted can be closed, and the movement of the glass run 2 toward the outside of the vehicle can be restricted. As a result, the stability of the state in which the glass run 2 is mounted can be enhanced, and hence, the improvement in sealing characteristic can be realized, thereby making it possible to suppress the generation of wind noise.

Since the extending lip 20 takes the so-called form of a lip and is brought into elastic contact or press contact with the bottom wall part 30 of the retainer S1, when compared with a case where a projection such as a bead which contacts with the bottom wall part 30 of the retainer S1, the contact area is extended, so that the contact with the bottom wall part 30 of the retainer S1 is ensured further and the aforesaid function and advantage are provided in a more ensured fashion. Furthermore, since the extending lip 20 extends from the substantially distal end of the engagement projection 17 and is formed to be bent so as to have the substantially V-shaped cross section to thereby become convex toward the engagement recess 33, the elastic force can be obtained in a more ensured fashion, and the engagement projection 17 can easily be fitted in the engagement recess 33. As a result, the reduction in working efficiency during the fitting work can be suppressed. Hence, since the protruding amount is increased by such an extent that the extending lip 20 extends, the engagement projection 17 becomes easier to be inserted, thereby making it possible to increase the working efficiency.

In addition, since the engagement projection 17 is urged against the interior wall surface of the engagement recess 33 due to the elastic force of the extending lip 20, the engagement projection 17 is made difficult to be dislocated from the engagement recess 33, thereby making it possible to increase further the stability of the state in which the glass run 2 is mounted.

Note that the invention is not limited to what has been described in the embodiment but may be embodied in the following manners. It goes without saying that other application and modification examples than those that will be illustrated below are, of course, possible.

(a) While, in the embodiment, the glass run 2 is specifically described as being applied to the front door 1, there is no limitation on the location on the door where the glass run 2 is applied, and therefore, the glass run 2 can be applied to, for example, a rear door.

(b) In the embodiment, the glass run 2 is constructed so as to be mounted when the pair of upper and lower engagement projections 17, 18 which are provided on the interior side surface of the interior wall part 11 are fitted in the retainer S1 which is made to open toward the outside of the vehicle. However, the position where the engagement projections 17, 18 are provided is not limited to the interior wall part 11. For example, a configuration may be adopted in which the engagement projections 17, 18 are provided on the base portion 10, so that the engagement projections 17, 18 are fitted in a retainer which is made to open downwards. In this case, a similar bending portion to the bending portion 22 will be provided on the base portion 10.

(c) The number, position and shape of the extending lip 20 are not limited to those described in the embodiment. For example, a configuration may be adopted in which extending lips 20 extend, respectively, from both the engagement projections 17, 18. In addition, a configuration may be adopted in which the extending lip 20 is formed to extend directly from the interior side surface of the interior wall part 11. Additionally, the shape of the extending lip 20 is not limited to the shape resulting when the extending lip 20 is formed to be bent so as to have the substantially V-shaped cross section, and a substantially rectilinear shape like the seal lips 14, 15 may be adopted.

In addition, a configuration may be adopted in which the extending lip 20 is omitted. In this case, the thickness of the engagement projections 17, 18 and the depth of the retainer S1 (the engagement recesses 33, 34) can be made substantially the same in space. Even with this configuration, according to the configuration of the embodiment, the engagement projections 17, 18 can be fitted in the retainer S1 (the engagement recesses 33, 34) relatively easily. In other words, the depth of the retainer S1 (the engagement recesses 33, 34) does not have to be set extremely deeper, and it becomes difficult to generate a gap between the engagement projections 17, 18 and the bottom wall part 30 of the retainer S1 in such a state that the glass run 2 is mounted. As a result, the loosening of the glass run 2 is made difficult to be generated in inward and outward directions of the vehicle, thereby making it possible to enhance the stability of the state in which the glass run 2 is mounted.

(d) The thickness of the bending portion 22 may be made thinner than that of other locations on the interior wall part 11. In place of or in addition to this configuration, a configuration may be adopted in which a notched portion is provided in the bending portion 22. According to this configuration, the bending portion 22 is made easier to be deformed to be bent, thereby making it possible to realize a further improvement in the mount workability of the glass run 2.

What is claimed is:

1. A glass run adapted to be mounted on a vehicle door having a door glass which moves up and down, comprising:
a main body with a substantially U-shaped cross section which includes a base portion, and an interior wall part and an exterior wall part which extend, respectively, from opposite ends of said base portion;
a pair of seal lips which extend, respectively, from said interior wall part and said exterior wall part toward an inside of said main body so as to provide a seal to said door glass;
a pair of engagement projections provided so as to be brought into engagement with a pair of engagement recesses provided in a substantially C-shaped mount portion of said vehicle door; and
a bending portion formed between said engagement projections so as to be deformable to become convex toward an inside of said U-shaped cross section of said main body.

2. A glass run according to claim 1, wherein
said pair of engagement projections are provided in said interior wall part so as to be brought into engagement with said pair of engagement recesses provided in said mount portion of said vehicle door, which opens toward an outside of said vehicle; and
said bending portion is formed between said engagement projections so as to be deformable such that said interior wall part becomes convex toward said outside of said vehicle.

3. A glass run according to claim 2, wherein an interior side surface of said interior wall part is formed in a substantially V-shaped cross section such that a distance between an exterior side surface and said interior side surface in said interior wall part becomes gradually shorter from said respective engagement projections toward said bending portion.

4. A glass run according to claim 1, further comprising an extending wall part which extends from a distal end of said interior wall part so as to be locked on a predetermined locking portion.

5. A glass run adapted to be mounted on a vehicle door having a door glass which moves up and down, comprising:
a main body with a substantially U-shaped cross section which includes a base portion, and an interior wall part and an exterior wall part which extend, respectively, from opposite ends of said base portion;
a pair of seal lips which extend, respectively, from said interior wall part and said exterior wall part toward an inside of said main body so as to provide a seal to said door glass;
a pair of engagement projections provided so as to be brought into engagement with a pair of engagement recesses provided in a substantially C-shaped mount portion of said vehicle door; and
at least an extending lip projected from said engagement projection or said main body which is bent to provide a press contact with a bottom portion of said mount portion.

6. A glass run according to claim 5, wherein said extending lip is formed to have a substantially V-shaped cross section.

7. A glass run adapted to be mounted on a vehicle door having a door glass which moves up and down, comprising:
a main body with a substantially U-shaped cross section which includes a base portion, and an interior wall part and an exterior wall part which extend, respectively, from opposite ends of said base portion;
a pair of seal lips which extend, respectively, from said interior wall part and said exterior wall part toward an inside of said main body so as to provide a seal to said door glass;
a pair of engagement projections provided on an interior side surface of said interior wall part along an extending direction of said interior wall part so as to be brought into engagement with a pair of engagement recesses provided in a substantially C-shaped mount portion of said vehicle door; and
an extending lip which extends from at least one of said engagement projections to provide a press contact with a bottom portion of said mount portion.

8. A glass run according to claim 7, wherein said extending lip extends from a distal end of said engagement projection and is formed to have a substantially V-shaped cross section so as to become convex toward the engagement recess which corresponds to said engagement projection.

9. A glass run according to claim 8, wherein said engagement projection from which said extending lip extends is made to be urged against an interior wall surface of said engagement recess which corresponds to said engagement projection.

10. A glass run according to claim 7, wherein said extending lip is provided on at least one of said engagement projections which is located on a base portion side.

11. A glass run according to claim 7, wherein said engagement projections and said extending lip are provided on at least a portion which corresponds to an upper portion of said glass run.
